(19) United States
(12) Patent Application Publication
(10) Pub. No.: US 2025/0310581 A1
(43) Pub. Date: Oct. 2, 2025

(54) Controlling a Streaming Server Remotely Via Multipath Connections

(71) Applicant: ATI Technologies ULC, Markham (CA)

(72) Inventors: Gennadiy Kolesnik, Richmond Hill (CA); Mikhail Mironov, Richmond Hill (CA)

(73) Assignee: ATI Technologies ULC, Markham, ON (CA)

(21) Appl. No.: 18/618,168

(22) Filed: Mar. 27, 2024

(51) Int. Cl. H04N 21/2387; G06F 9/455; H04N 21/4227

(52) U.S. Cl. CPC H04N 21/2387; G06F 9/455; H04L 65/1013; H04N 21/4227

(57) ABSTRACT

A media streaming system is described. In accordance with the described techniques, a client input device includes a memory to store code configured to emulate one or more peripheral devices and a processor coupled with the memory. The processor causes the client input device to establish, via a network, a first connection to a streaming server. Based on an input received at the client input device, the processor causes the client input device to generate an input message that requests the streaming server provide content to a streaming client device over a second connection separate from the first connection, wherein the input message emulates an input event at a peripheral device of the streaming server. The processor causes the client input device to transmit, via the first connection, the input message to the streaming server.

### BACKGROUND

Streaming media services provide media over communication networks such as the Internet, cellular networks, wireless networks, and so on. Streaming media includes multimedia that is delivered and consumed in a continuous manner from a source, with little or no intermediate storage in network elements. The content provided by streaming media services include movies, music, online gaming, video conferencing, software applications, messaging applications, productivity applications, and the like. Streaming media services may operate based on a variety of protocols such as streaming protocols, Internet protocols, real-time transport protocols, and the like.

### BRIEF DESCRIPTION OF THE DRAWINGS

FIG. 1 is a block diagram of a non-limiting example a media streaming system with logic for controlling a streaming server remotely based on multipath connections.

FIG. 2 is a block diagram of a non-limiting example implementation of a media streaming system.

FIG. 3 is a flow diagram depicting an algorithm as a step-by-step procedure in an example of controlling a streaming server remotely based on multipath connections.

FIG. 4 is a flow diagram depicting an algorithm as a step-by-step procedure in an example of controlling a streaming server remotely based on multipath connections.

FIG. 5 is a flow diagram depicting an algorithm as a step-by-step procedure in another example of controlling a streaming server remotely based on multipath connections.

### DETAILED DESCRIPTION

### Overview

Conventional approaches for providing streaming media services from a streaming server (e.g., a streaming media server, a remote media server, a remote application server, or any computing device serving content) to a streaming client device (e.g., a television, display device, laptop, etc.) assume that there is one (e.g., only one) streaming client device per session and thus only one connection per session, e.g., a connection between the streaming client device and the streaming server. In some conventional approaches, a game is streamed to two or more client devices, each device equipped with a respective input device. In these conventional approaches, the streaming client device displays a user interface for an application running on the streaming server and input devices providing input to the application connected directly to the streaming client device. However, access to streaming media services is limited when an input device, such as a wireless keyboard or game controller, cannot be connected directly to the streaming client device. For example, if the streaming client device is implemented as a television, access to the streaming client device various input devices, such as game controllers or wireless keyboards, may be restricted if the television is not equipped with an application programming interface that supports such input devices.

In one or more examples, a connection between the input device and the streaming client device is not available (e.g., the streaming client device does not support pairing with the input device, radio frequency interference, blocked by security protocols, etc.). Additionally or alternatively, a direct connection between the input device and the streaming server is not available (e.g., streaming server is located off-site, streaming server is too far for a wired or wireless connection, etc.).

To overcome these problems, the described techniques provide streaming controller logic that includes logic, hardware, and/or software to enable the multipath connection streaming server control functionality described herein. The streaming controller logic enables a client input device (e.g., a smartphone emulating an input device, a tablet emulating an input device, a laptop emulating an input device, a wireless keyboard, a wireless mouse, a remote control, or any combination thereof) to establish a first connection to a streaming server (e.g., a remote streaming server) that is separate from a second connection established between the streaming server and the streaming client device. Thus, the described techniques contrast with conventional approaches in which a common connection to the streaming server is formed between the streaming server and the streaming client device, while an input device is connected to the streaming client device (e.g., via a wired or wireless connection).

When a connection between an input device (e.g., a game controller, wireless keyboard, wireless mouse, etc.) and the streaming client device is unavailable and/or a direct connection (e.g., wired connection) between the input device and the streaming server is unavailable, a client input device enhanced with the streaming controller logic enables the client input device to establish a connection to the streaming server that is independent of another connection between the streaming server and the streaming client device. In one or more examples, the streaming controller logic enables a client input device to emulate an input device of the streaming server (e.g., emulate an input device connected directly to the streaming server). Thus, instead of pairing the client input device with the streaming client device displaying content from the streaming server, the streaming controller logic establishes an independent connection with the streaming server that is separate from another connection between the streaming server and the streaming client device. The streaming controller logic establishes the independent connection between the streaming server and the client input device over one or more networks. The streaming controller logic enables the client input device to act as an input device for an application streaming to the streaming client device over the connection between the streaming server and the streaming client device. The streaming controller logic enables the client input device to act as an input device without the application streamed by the server being aware that the client input device is connected to the streaming server independently of the connection between the streaming server and the streaming client device.

The streaming controller logic provides multiple advantages. For example, the streaming controller logic enables a client input device to establish a connection to a streaming server that is independent of a connection between the streaming server and a streaming client device. Additionally or alternatively, the multipath connection functionality of the streaming controller logic enables a client input device to control an application streaming to a streaming client device when a connection between the client input device and the streaming client device is unavailable. Additionally or alternatively, the multipath connection functionality of the streaming controller logic enables a client input device to control an application streaming to a streaming client device when a direct connection between the client input device and the streaming server is unavailable. These advantages increase the availability of applications and content provided by streaming servers. Additionally, these advantages increase the utility and capabilities of input devices and increase the utility and interactivity of content provided by streaming servers.

In some aspects, the techniques described herein relate to a client input device including: a memory to store code configured to emulate one or more peripheral devices, and a processor coupled with the memory, the processor configured to cause the client input device to: establish, via a network, a first connection to a streaming server, based on an input received at the client input device, generate an input message that requests the streaming server provide content to a streaming client device over a second connection separate from the first connection, wherein the input message emulates an input event at a peripheral device of the streaming server, and transmit, via the first connection, the input message to the streaming server.

In some aspects, the techniques described herein relate to a client input device, wherein the input message requests the streaming server to provide a first portion of the content to the streaming client device and provide a second portion of the content to the client input device.

In some aspects, the techniques described herein relate to a client input device, wherein further instructions are executable by the processor to cause the client input device to receive the second portion of the content from the streaming server.

In some aspects, the techniques described herein relate to a client input device, wherein the first portion of the content includes video generated in response to the input message and the second portion of the content includes audio generated in response to the input message.

In some aspects, the techniques described herein relate to a client input device, wherein the peripheral device includes a virtual peripheral device of the streaming server being emulated on the client input device or a physical peripheral device connected to the client input device via a wired connection or a wireless connection.

In some aspects, the techniques described herein relate to a client input device, wherein the input is received from the physical peripheral device connected to the client input device.

In some aspects, the techniques described herein relate to a client input device, wherein the input message emulates the input event at a virtual peripheral device of one or more virtual peripheral devices of the streaming server, and wherein the one or more virtual peripheral devices include at least one of a keyboard, a mouse, a game controller, a touch screen, or a television remote control.

In some aspects, the techniques described herein relate to a streaming server including: a memory to store code configured to provide one or more virtual peripheral devices, and a processor coupled with the memory, the processor configured to cause the streaming server to: establish, via a network, a first connection between the streaming server and a client input device and a second connection between the streaming server and a streaming client device that is independent of the first connection, receive, via the first connection, an input message from the client input device, process the input message as a virtualized local input of a virtual peripheral device at the streaming server, generate content for the streaming client device based on the virtualized local input, and transmit, via the second connection, the content to the streaming client device.

In some aspects, the techniques described herein relate to a streaming server, wherein the input message requests the streaming server to provide a first portion of the content to the streaming client device and provide a second portion of the content to the client input device.

In some aspects, the techniques described herein relate to a streaming server, wherein further instructions are executable by the processor to cause the streaming server to send the first portion of the content to the streaming client device and send the second portion of the content to the client input device.

In some aspects, the techniques described herein relate to a streaming server, wherein the first portion of the content includes video generated by the streaming server in response to the input message and the second portion of the content includes audio generated by the streaming server in response to the input message.

In some aspects, the techniques described herein relate to a streaming server, wherein the one or more virtual peripheral devices include at least one of a keyboard, a mouse, a game controller, a touch screen, or a television remote control, and wherein the one or more virtual peripheral devices include the virtual peripheral device.

In some aspects, the techniques described herein relate to a streaming server, wherein the input message is processed based on a virtual device driver of the virtual peripheral device.

In some aspects, the techniques described herein relate to a streaming server, wherein the input message is processed based on an event injection application programming interface running at the streaming server.

In some aspects, the techniques described herein relate to a method including: receiving an input via an interface of a client input device, establishing, via a network, a first connection to a streaming server, generating, based on the input, an input message that requests the streaming server provide content to a streaming client device over a second connection separate from the first connection, wherein the input message emulates an input event at a peripheral device of the streaming server, and transmitting, via the first connection, the input message to the streaming server.

In some aspects, the techniques described herein relate to a method, further including configuring the input message to request the streaming server to provide a first portion of the content to the streaming client device and provide a second portion of the content to the client input device.

In some aspects, the techniques described herein relate to a method, further including receiving the second portion of the content from the streaming server.

In some aspects, the techniques described herein relate to a method, wherein the first portion of the content includes video generated in response to the input message and the second portion of the content includes audio generated in response to the input message.

In some aspects, the techniques described herein relate to a method, wherein the peripheral device includes a virtual peripheral device of the streaming server being emulated on the client input device or a physical peripheral device connected to the client input device via a wired connection or a wireless connection.

In some aspects, the techniques described herein relate to a method, wherein the input is received from the physical peripheral device connected to the interface of the client input device.

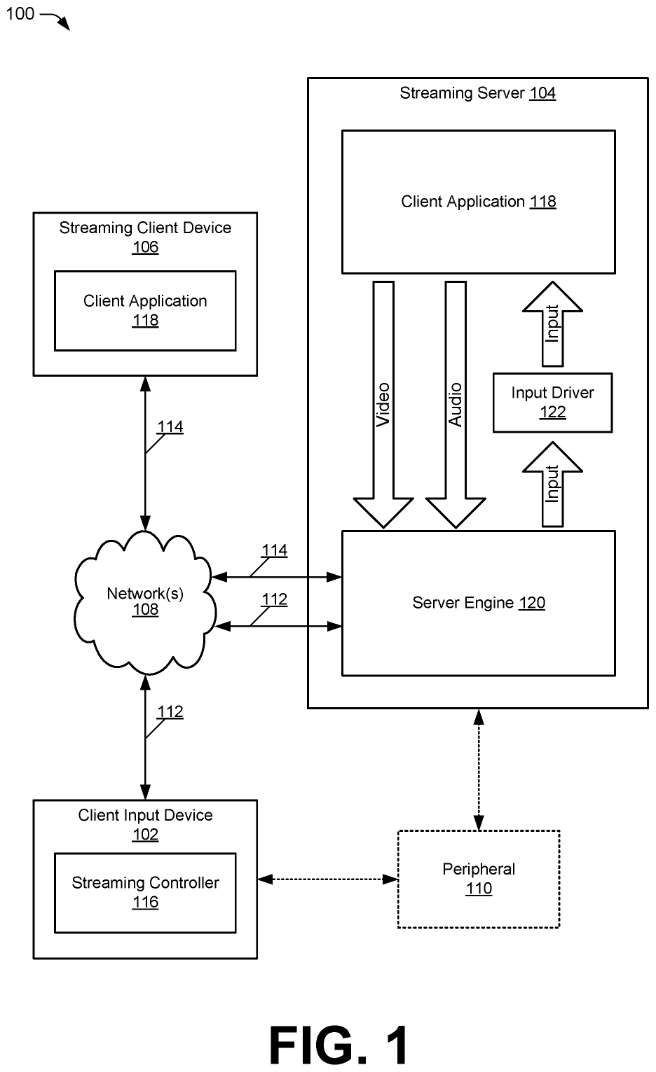

FIG. 1 is a block diagram of a non-limiting example of a media streaming system 100 with logic for controlling a streaming server remotely based on multipath connections.

In the illustrated example, the media streaming system 100 includes a client input device 102, a streaming server 104, a streaming client device 106, a communication network 108, and a peripheral 110. Examples of client input device 102 include a smartphone, a tablet, a laptop, a wireless keyboard, a wireless mouse, a remote control, a wireless peripheral device, a wired peripheral device connected to a computing device, or any combination thereof. Examples of the streaming server 104 include a streaming media server, a remote media server, a remote application server, or any computing device serving content to one or more devices (e.g., remote devices). Examples of the streaming client device 106 include a television, a display device, a laptop, any computing device with a screen, etc. Examples of the peripheral 110 include a wireless keyboard, a wireless mouse, a remote control. In one or more examples, the peripheral 110 is connected to the client input device 102 via a wired or wireless connection.

As shown, a connection 112 is established (e.g., via the communication network 108) between the streaming server 104 and the client input device 102. Also, a connection 114 is established (e.g., via the communication network 108) between the streaming server 104 and the streaming client device 106. In one or more examples, the client input device 102 includes a streaming controller 116 (e.g., streaming controller logic), the streaming server 104 includes a client application 118, a server engine 120, and an input driver 122. In one or more variations, the streaming client device 106 runs an instance of the client application 118 (e.g., the streaming server 104 streams the client application 118 to the streaming client device 106).

In the illustrated example, the client input device 102 connects to a physical peripheral device (e.g., the peripheral 110) such as a keyboard, a mouse, a joystick, a game controller, a touch screen. In one or more examples, the peripheral 110 connects to the client input device 102 via a wired connection (e.g., via universal serial bus) and/or wirelessly (e.g., via BLUETOOTH®, WIFI®, etc.). Additionally or alternatively, the client input device 102 emulates a peripheral device (e.g., the peripheral 110) with virtual controls displayed on a display of the client input device 102. In one or more examples, the client input device 102 emulates a keyboard with an on-screen keyboard or a game controller with an on-screen game controller displayed on a display of the client input device 102 (e.g., on a screen of a smartphone, tablet, laptop, etc.). In one or more variations, the client input device 102 connects to the streaming server 104 and receives input events from the peripheral 110 (e.g., a physical peripheral device or an emulated peripheral device)

The streaming server 104 runs one or more applications (e.g., the client application 118). As shown, the client application 118 is streamed to the streaming client device 106 over the connection 114. The connection 112 and/or the connection 114 include, but are not limited to, an Ethernet connection, WIFI® connection, cellular connection, a combination of thereof, etc. The server engine 120 is configured to capture content (e.g., media, video content, audio content, etc.) produced by the client application 118. The server engine 120 is configured to encode the content and send at least a portion of the encoded content to the streaming client device 106. The input driver 122 implements virtual device drivers to enable the streaming server 104 to simulate one or more input devices (e.g., the peripheral 110 as a virtual peripheral device). In one or more examples, the streaming server 104 is implemented on one or more computing devices, including, but not limited to, a personal computer, a laptop, a smartphone, a server, a virtual machine, or a container running on a server device.

The streaming client device 106 runs the client application 118. The client application 118 enables the streaming client device 106 to receive, decode, and output content (e.g., display video and/or play audio) streamed to the streaming client device 106 from the streaming server 104 via the connection 114. In one or more examples, the streaming client device 106 is a television (e.g., smart television), a game console, a thin client personal computer, a laptop, a set-top box, a single board computer, or any other computer-like device or combination thereof that is capable of being connected to the streaming server 104 via the connection 114.

In one or more examples, the client input device 102 establishes (e.g., via the communication network 108) connection 112 to the streaming server 104. Additionally or alternatively, the streaming server 104 establishes connection 112 between the streaming server 104 and the client input device 102 and establishes connection 114 between the streaming server 104 and the streaming client device 106. As shown, connection 112 is separate and independent of connection 114.

The streaming controller 116 of the client input device 102 generates an input message based on an input received at the client input device 102 (e.g., received at the peripheral 110). The streaming controller 116 sends the input message to the streaming server 104 over the connection 112. In one or more examples, the input message requests the streaming server 104 provide content to the streaming client device 106 over connection 114 separate from connection 112, where the content being streamed is altered in response to the input message (e.g., a flash graphic is added to content being streamed to visually depict an explosion, a boom sound is added to the content being streamed to aurally depict the explosion, etc.). The streaming server 104 renders and provides media content to the streaming client device 106 continuously regardless of the input from controllers or other input devices. However, when a user manipulates a control on an input device, the content being rendered is altered (e.g., modified, augmented) to reflect the message received from the input device. In one or more variations, the input message received from the client input device 102 (or the streaming controller 116) triggers the corresponding input event from the peripheral 110 through input driver 122 as if the peripheral 110 was connected directly to the streaming server 104.

The server engine 120 of the streaming server 104 receives, via connection 112, an input message from the client input device 102. The streaming server 104, in conjunction with the input driver 122 (e.g., virtual input device driver), processes the input message as a virtualized local input of a virtual peripheral device (e.g., the peripheral 110 as a virtual peripheral device connected to the streaming server 104). The client application 118 at the streaming server 104 generates content for the streaming client device 106 based on the virtualized local input. The server engine 120 captures the content from the client application 118. In one or more variations, the server engine 120 encodes the captured content and the server engine 120 transmits the encoded content to the streaming client device 106 via the connection 114.

From the perspective of the streaming server 104, the peripheral 110 is a virtual peripheral device of the streaming server 104. In one or more examples, the input driver 122 of the streaming server 104 handles an input message from the client input device 102 as a virtual input event of the virtual peripheral device of the streaming server 104. In one or more examples, the peripheral 110 represents one or more virtual peripheral devices of the streaming server 104, where the one or more virtual peripheral devices include at least one of a virtual keyboard, a virtual mouse, a virtual game controller, a virtual touch screen, or a virtual television remote control. In one or more examples, the input message is processed by the server engine 120 and the input driver 122 based on one or more virtual device drivers of the input driver 122. Additionally or alternatively, the input message is processed by the server engine 120 and the input driver 122 based on an event injection application programming interface running in conjunction with an operating system of the streaming server 104.

Additionally or alternatively, from the perspective of the client input device 102, the peripheral 110 is an emulated peripheral device of the client input device 102. In one or more examples, the streaming controller 116 of the client input device 102 receives a user input (e.g., user tapping touchscreen, user voice command, user pressing physical button, etc.) and the streaming controller 116 generates an input message of the emulated peripheral device of the client input device 102 (e.g., the peripheral 110).

Additionally or alternatively, from the perspective of the client input device 102, the peripheral 110 is a physical peripheral device connected to the client input device 102 by a wired or wireless connection. In one or more examples, the physical peripheral device connected to the client input device 102 (e.g., the peripheral 110) generates an input message based on user input at the physical peripheral device (e.g., user pressing a button of a game controller, user typing on a keyboard, user scrolling a mouse, user tapping a touchscreen, user swiping a touchpad, etc.). The streaming controller 116 captures the input message and transmits the input message to the streaming server 104.

The described techniques provide a system where the streaming client device and the client input device are different physical devices, which connect to the streaming server independently of each other. Each of the streaming client device and the client input device maintain their own connection which utilize either the same or different network paths and technologies. For example, in one or more examples, the streaming client device may be a smart television connected to the streaming server via a wired Ethernet connection. The client input device may be a smart phone connected to the streaming server via WIFI® or cellular, where the touchscreen of the phone can serve as a touchpad to control the mouse on the streaming server, while a physical keyboard is connected to the client input device via BLUETOOTH®. Additionally or alternatively, the peripheral 110 (e.g., a game controller, etc.) may be docked into and connected to the client input device 102 via universal serial bus.

The client input device 102 captures and sends input events such as keyboard presses, mouse movement and clicks, game controller button presses, etc. to the streaming server 104. The streaming server 104 receives, decodes and injects these input events into the client application 118 via the input driver 122 as if the input events originate at the peripheral 110 (e.g., as a virtual peripheral device connected to the streaming server 104).

In one or more examples, the input driver 122 implements virtual device drivers to simulate virtual peripheral devices (e.g., peripheral 110). Additionally or alternatively, the input driver 122 implements event injection application programming interfaces in conjunction with an operating system running on the streaming server 104 to simulate the virtual peripheral devices.

The client application 118 running on the streaming server 104 receives and handles these input events and renders the content (e.g., media, video content, audio content). The client application 118 outputs the rendered content and the server engine 120 captures this content. The server engine 120 then encodes the content and sends at least a portion of the encoded content (e.g., at least one video frame, at least one audio buffer) to the client application 118 via the connection 114.

Consider an illustrative example scenario of the media streaming system 100 where the streaming controller 116 detects user input relative to the peripheral 110 (e.g., emulated by the client input device 102 or a physical peripheral device connected to the client input device 102). For example, the streaming controller 116 detects a button being pressed on a game controller, a key being clicked on a keyboard, a mouse being clicked and dragged, a mouse being scrolled, a touchscreen being tapped, a touchpad being swiped, or a combination thereof. The streaming controller 116 generates an input message based on the detected user input. The streaming controller 116 sends the input message to the streaming server 104. In one or more examples, the server engine 120 of the streaming server 104 receives and decodes the input message. The server engine 120 treats the input message as an input of a peripheral connected to the streaming server 104 (e.g., the peripheral 110).

In the illustrative example scenario, the server engine 120 provides the decoded message to the input driver 122. The input driver 122, in conjunction with the operating system of the streaming server 104, handles the decoded message as a virtualized local input and submits the virtualized local input to the client application 118, as if the virtualized local input originated at the peripheral 110 (e.g., as a virtualized peripheral device).

In the illustrative example scenario, the client application 118 generates content (e.g., media, video content, audio content, etc.) based on the virtualized local input. The client application 118 outputs the content to the server engine 120. The content includes at least one of audio output or video output, where the video output includes one or more video frame(s) and the audio output includes one or more audio buffer(s).

In the illustrative example scenario, the server engine 120 captures the content generated and provided by the client application 118. In one or more examples, the server engine 120 encodes the content. For example, the server engine 120 encodes video output using one or more video codecs (e.g., H.264, HEVC, AV1, etc.) and/or encodes audio output using one or more audio codecs (e.g., aac, mp3, OPUS, etc.).

In the illustrative example scenario, the server engine 120 serves the encoded content to the streaming client device 106 over the connection 114 (via the communication network 108). The streaming client device 106 receives and decodes the content and the content is presented on the streaming client device 106. For example, when the content includes audio, the streaming client device 106 decodes the audio and plays the audio on a speaker of the streaming client device 106. When the content includes video, the streaming client device 106 decodes the video and plays the video on a display of the streaming client device 106.

The streaming controller logic of the streaming controller 116 expands the range of input devices that can cooperate with streaming clients such as the streaming client device 106. For example, the streaming controller logic of the streaming controller 116 enables a smart television or a set-top box not configured to be paired with physical input devices such as keyboards, computer mice, game controllers, smartphones, etc., to be used as a display with such physical input devices when the physical input devices are enhanced with the streaming controller 116. Thus, the streaming controller logic of the streaming controller 116 reduces the overall cost of ownership of media devices by enabling existing physical input devices (e.g., the client input device 102) to connect to streaming servers independent of streaming client connections.

The streaming controller logic provides multiple advantages. For example, the streaming controller logic of the streaming controller 116 enables the client input device 102 to establish the connection 112 to the streaming server 104 that is independent of the connection 114 between the streaming server 104 and the streaming client device 106. Thus, the multi-connection functionality of the streaming controller 116 enables the client input device 102 to control the client application 118 streaming to the streaming client device 106 when a connection between the client input device 102 and the streaming client device 106 is unavailable. Additionally or alternatively, the multi-connection functionality of the streaming controller 116 enables the client input device 102 to control the client application 118 streaming to the streaming client device 106 when a direct connection between the client input device 102 and the streaming server 104 is unavailable. These advantages increase the availability of applications and content provided by the streaming server 104 (e.g., the client application 118). Additionally, these advantages increase the utility and capabilities of the client input device 102 and increase the utility and interactivity of content provided by the streaming server 104 (e.g., the client application 118).

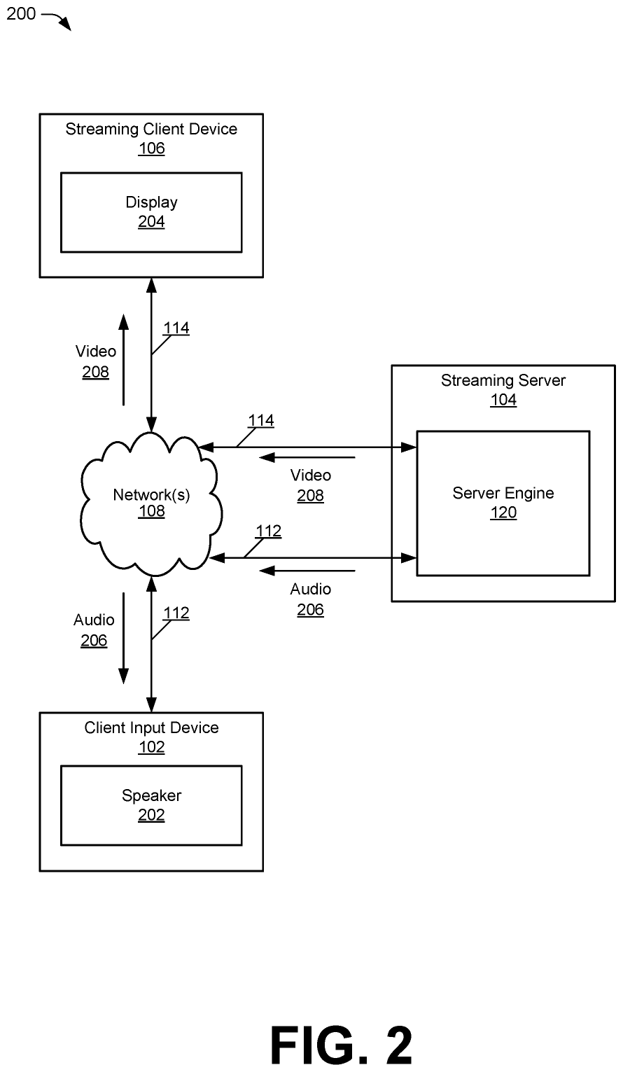

FIG. 2 is a block diagram of a non-limiting example of a media streaming system 200 of the media streaming system 100 of FIG. 1 in further detail. The media streaming system 200 depicts content being served by the streaming server 104. As shown, the client input device 102 includes a speaker 202 and the streaming client device 106 includes a display 204.

Consider an illustrative example scenario of the media streaming system 200 where an input message from the client input device 102 requests content from the streaming server 104. In the illustrative example scenario, the input message requests that the streaming server 104 provide a first portion of the content to the streaming client device 106 and provide a second portion of content to the client input device 102. As instructed, the streaming server 104 sends the first portion of the content to the streaming client device 106 and sends the second portion of the content to the client input device 102. The first portion of the content includes video 208 generated by the streaming server in response to the input message and the second portion of the content includes audio 206 generated by the streaming server 104 also in response to the input message.

In the illustrative example scenario, the server engine 120 captures content generated and provided by a client application (e.g., the client application 118). In one or more examples, the server engine 120 encodes the content. For example, the server engine 120 encodes the video 208 using one or more video codecs and encodes the audio 206 using one or more audio codecs.

In the illustrative example scenario, the server engine 120 serves the audio 206 to the client input device 102 over the connection 112. Also, the server engine 120 serves the video 208 to the streaming client device 106 over the connection 114.

In the illustrative example scenario, the client input device 102 receives and decodes the audio 206 and the decoded audio 206 is played on the client input device 102. For example, the client input device 102 decodes the audio 206 and plays the decoded audio 206 on the speaker 202 of the client input device 102. Simultaneously, the streaming client device 106 receives and decodes the video 208 and the video 208 is presented on the streaming client device 106. For example, the streaming client device 106 decodes the video 208 and plays the decoded video 208 on the display 204 of the streaming client device 106. Thus, in some cases the client input device 102 performs some of the functions of the streaming client device 106.

In one or more variations, the server engine 120 sends the audio 206 to the streaming client device to play on speakers of the streaming client device 106 and sends the video 208 to the client input device 102 to play on a display of the client input device 102. For example, the streaming client device 106could be a sound system without a display, while the client input device 102 could be a smart device equipped with a display and a touch screen.

The media streaming system 200 provides enhanced utility and interactivity of streaming servers such as the streaming server 104 by enabling independent concurrent connections to the streaming server 104 (e.g., the connection 112 and the connection 114). The independent concurrent connections enhance input devices by providing enhanced interactivity and enhanced availability of content served by the streaming server 104.

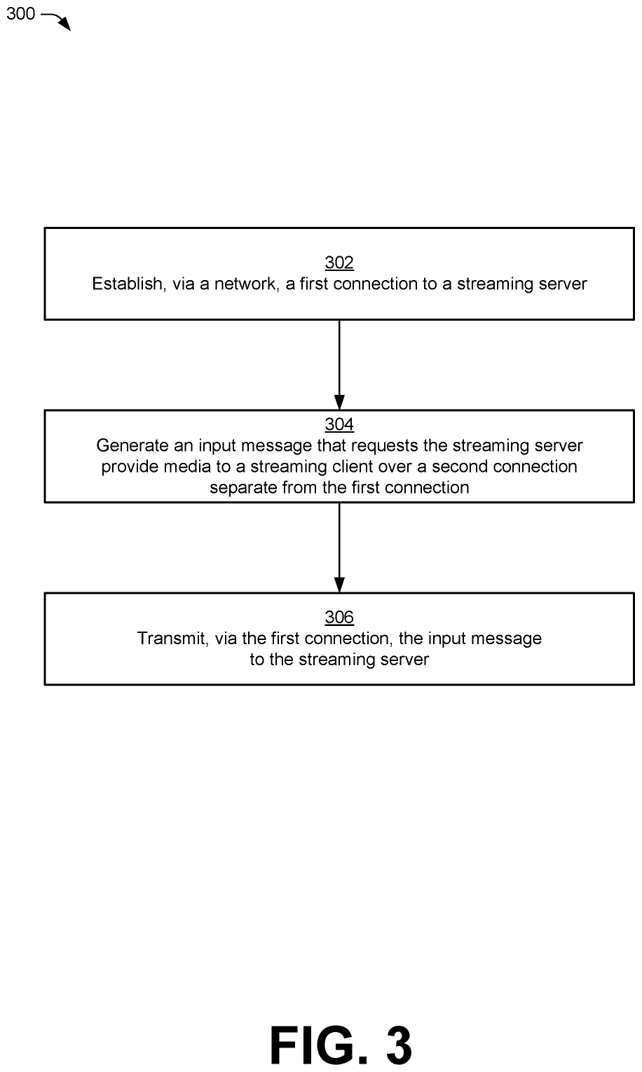

FIG. 3 is a flow diagram depicting an algorithm as a step-by-step procedure 300 in another example of controlling a streaming server remotely based on multipath connections.

A first connection is established, via a network, to a streaming server (block 302). For example, a client input device and the streaming server establish a first connection. A streaming client device and the streaming server establish a second connection independent of the first connection.

An input message is generated that requests the streaming server provide content to a streaming client device over a second connection separate from the first connection (block 304). In one or more examples, the input message is generated based on an input received at a client input device. The input message emulates an input event at a peripheral device of the streaming server (e.g., a virtual peripheral device of the streaming server).

The input message is transmitted to the streaming server via the first connection (block 306). For example, the input message is communicated to the streaming server via the first connection. The streaming server generates the requested content based on the input message and provides the content to the streaming client device via a second connection independent of the first connection.

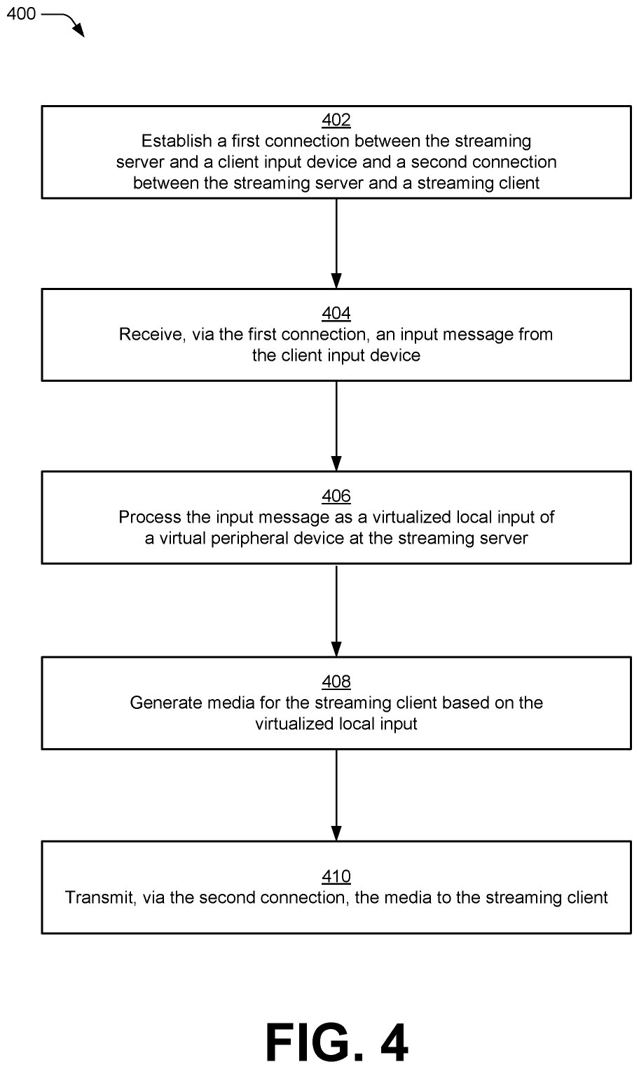

FIG. 4 is a flow diagram depicting an algorithm as a step-by-step procedure 400 in another example of controlling a streaming server remotely based on multipath connections.

A first connection between the streaming server and a client input device is established and a second connection between the streaming server and a streaming client device that is independent of the first connection is established (block 402). The first connection and the second connection are established via one or more communication networks. In one or more examples, the first connection is established via a first communication network and the second connection is established via a second communication network separate from the first communication network.

An input message is received from the client input device via the first connection (block 404). By way of example, the client input device detects an input, generates the input message, and communicates the input message to the streaming server over the first connection.

The input message is processed as a virtualized local input of a virtual peripheral device at the streaming server (block 406). For example, the streaming server receives the input message and handles the input message as an input of a peripheral device (e.g., virtual peripheral device) connected to the streaming server.

Content is generated for the streaming client device based on the virtualized local input (block 408). For example, the streaming server provides the virtualized local input to a client application and the client application generates content based on the virtualized local input.

The content is transmitted to the streaming client device via the second connection (block 410). For example, the input message is sent by the client input device to the streaming server over the first connection and then the streaming server provides the content generated in response to the input message to the streaming client device over the independent second connection.

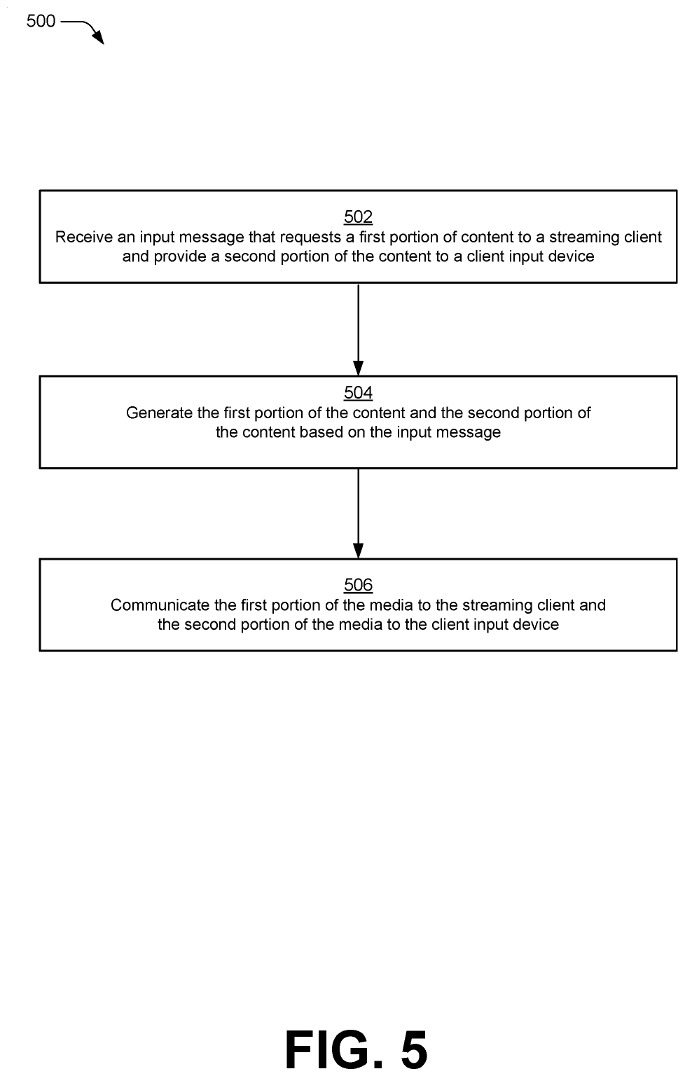

FIG. 5 is a flow diagram depicting an algorithm as a step-by-step procedure 500 in an example of controlling a streaming server remotely based on multipath connections. In one or more implementations, at least a portion of the procedure 500 is executed as a part of the procedure 300 of FIG. 3 and/or the procedure 400 of FIG. 4. Alternatively, the procedure 500 is executed separately from the procedure 300 and/or the procedure 400.

An input message is received that requests a first portion of content be sent to a streaming client device and a second portion of the content be sent to a client input device (block 502). For example, a streaming server receives the input message from a client input device over a first connection. The streaming server decodes the input message and determines the request of the input message to provide the first portion of the content to the streaming client device and the second portion of the content to the client input device.

The first portion of the content and the second portion of the content are generated based on the input message (block 504). For example, the streaming server generates the first portion of the content and generates the second portion of the content according to the request. In one or more examples, the first portion of the content includes video generated by the streaming server in response to the input message and the second portion of the content includes audio generated by the streaming server in response to the input message.

The first portion of the content is communicated to the streaming client device and the second portion of the content is communicated to the client input device (block 506). For example, the streaming server generates the first portion of the content and provides the first portion of the content to the streaming client device over the second connection. Also, the streaming server generates the second portion of the content and provides the second portion of the content to the client input device over the first connection.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the client input device 102, the streaming server 104, and the streaming client device 106) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), one or more Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A client input device comprising:
a memory to store code configured to emulate one or more peripheral devices; and
a processor coupled with the memory, the processor configured to cause the client input device to:
establish, via a network, a first connection to a streaming server;
based on an input received at the client input device, generate an input message that requests the streaming server provide content to a streaming client device over a second connection separate from the first connection, wherein the input message emulates an input event at a peripheral device of the streaming server; and
transmit, via the first connection, the input message to the streaming server.

2. The client input device of claim 1, wherein the input message requests the streaming server to provide a first portion of the content to the streaming client device and provide a second portion of the content to the client input device.

3. The client input device of claim 2, wherein further instructions are executable by the processor to cause the client input device to receive the second portion of the content from the streaming server.

4. The client input device of claim 2, wherein the first portion of the content includes video generated in response to the input message and the second portion of the content includes audio generated in response to the input message.

5. The client input device of claim 1, wherein the peripheral device includes a virtual peripheral device of the streaming server being emulated on the client input device or a physical peripheral device connected to the client input device via a wired connection or a wireless connection.

6. The client input device of claim 5, wherein the input is received from the physical peripheral device connected to the client input device.

7. The client input device of claim 1, wherein the input message emulates the input event at a virtual peripheral device of one or more virtual peripheral devices of the streaming server, and wherein the one or more virtual peripheral devices include at least one of a keyboard, a mouse, a game controller, a touch screen, or a television remote control.

8. A streaming server comprising:
a memory to store code configured to provide one or more virtual peripheral devices; and
a processor coupled with the memory, the processor configured to cause the streaming server to:
establish, via a network, a first connection between the streaming server and a client input device and a second connection between the streaming server and a streaming client device that is independent of the first connection;
receive, via the first connection, an input message from the client input device;
process the input message as a virtualized local input of a virtual peripheral device at the streaming server;
generate content for the streaming client device based on the virtualized local input; and
transmit, via the second connection, the content to the streaming client device.

9. The streaming server of claim 8, wherein the input message requests the streaming server to provide a first portion of the content to the streaming client device and provide a second portion of the content to the client input device.

10. The streaming server of claim 9, wherein further instructions are executable by the processor to cause the streaming server to send the first portion of the content to the streaming client device and send the second portion of the content to the client input device.

11. The streaming server of claim 9, wherein the first portion of the content includes video generated by the streaming server in response to the input message and the second portion of the content includes audio generated by the streaming server in response to the input message.

12. The streaming server of claim 8, wherein the one or more virtual peripheral devices include at least one of a keyboard, a mouse, a game controller, a touch screen, or a television remote control, and wherein the one or more virtual peripheral devices include the virtual peripheral device.

13. The streaming server of claim 8, wherein the input message is processed based on a virtual device driver of the virtual peripheral device.

14. The streaming server of claim 8, wherein the input message is processed based on an event injection application programming interface running at the streaming server.

15. A method comprising:
receiving an input via an interface of a client input device;
establishing, via a network, a first connection to a streaming server;
generating, based on the input, an input message that requests the streaming server provide content to a streaming client device over a second connection separate from the first connection, wherein the input message emulates an input event at a peripheral device of the streaming server; and
transmitting, via the first connection, the input message to the streaming server.

16. The method of claim 15, further comprising configuring the input message to request the streaming server to provide a first portion of the content to the streaming client device and provide a second portion of the content to the client input device.

17. The method of claim 16, further comprising receiving the second portion of the content from the streaming server.

18. The method of claim 16, wherein the first portion of the content includes video generated in response to the input message and the second portion of the content includes audio generated in response to the input message.

19. The method of claim 15, wherein the peripheral device includes a virtual peripheral device of the streaming server being emulated on the client input device or a physical peripheral device connected to the client input device via a wired connection or a wireless connection.

20. The method of claim 19, wherein the input is received from the physical peripheral device connected to the interface of the client input device.
